(19) United States
(12) Patent Application Publication
(10) Pub. No.: US 2018/0123236 A1
(43) Pub. Date: May 3, 2018

(54) Antenna System and Antenna Module With a Parasitic Element For Radiation Pattern Improvements

(71) Applicants: TE Connectivity Nederland BV, s'Hertogenbosch (NL); TE Connectivity Germany GmbH, Bensheim (DE)

(72) Inventors: Wijnand Van Gils, Raamsdonksveer (NL); Luc Van Dommelen, Udenhout (NL); Sheng-Gen Pan, Kamp-Lintfort (DE); Christian Rusch, Karlsruhe (DE); Andreas Winkelmann, Sindelfingen (DE); Daniel Volkmann, Lautertal (DE)

(73) Assignees: TE Connectivity Nederland BV, S'Hertogenbosch (NL); TE Connectivity Germany GmbH, Bensheim (DE)

(21) Appl. No.: 15/801,906

(22) Filed: Nov. 2, 2017

Related U.S. Application Data
(63) Continuation of application No. PCT/EP2016/060005, filed on May 4, 2016.

(30) Foreign Application Priority Data
May 4, 2015 (EP) 15166282.2

(51) Int. Cl. H01Q 1/52; H01Q 21/28; H01Q 1/32; H01Q 9/04

(52) U.S. Cl. CPC H01Q 1/523; H01Q 21/28; H01Q 5/307; H01Q 9/0428; H01Q 9/0414; H01Q 1/3275

(57) ABSTRACT

An antenna system and antenna module incorporating the antenna system. The antenna system has a first planar antenna element and at least one second antenna element which are arranged along an axis. Also included within the near-field of the first planar antenna element is a planar parasitic element arranged substantially in parallel to the first planar antenna element and being arranged at a predetermined distance therefrom. The center of the planar parasitic element is offset, with respect to the center of the first planar antenna element, in a direction away from the at least one second antenna element along the axis. The deformation of the radiating pattern of the first planar antenna element, due to interference with the at least one second antenna element, is reduced.

### CROSS-REFERENCE TO RELATED APPLICATIONS

This application is a continuation of PCT International Patent Application No. PCT/EP2016/060005 filed May 4, 2016, which claims priority under § 119 to European Patent Application 15166282.2 filed May 4, 2015.

### FIELD OF THE INVENTION

The present invention relates, in general, to antenna systems and, in particular, to an antenna system having a first antenna element, a second antenna element, and a parasitic element that provides an improvement of the radiation pattern of at least one of the antenna elements. Further, the present invention relates to an antenna module that incorporates the antenna system.

### BACKGROUND

In the context of the present invention, an antenna system is to be understood as an antenna arrangement that includes a first antenna element and a second antenna element.

Generally, antenna systems are widely discussed in technology because the grouping of plural antenna elements in one system provides for various structural advantages. In particular, the assembly of an antenna system as a single structural module allows mechanical and electrical components to be shared between the plural antenna elements.

Accordingly, in an antenna system, the plural antenna elements may be arranged within the same housing and share the same housing, the same base, the same antenna circuitry, and the same electrical connection element (e.g., socket/plug) for transmitting/receiving electrical signals from the outside to/from the plural antenna elements within the antenna system, respectively.

However, the arrangement of plural antenna elements in an antenna system can suffer from disadvantages, particularly when the plural antenna elements are arranged in the near-field to each other. In this case, the plural antenna elements can suffer from mutual interference effects, particularly regarding their respective radiating patterns.

In WO 98/26471 A1, it is proposed to apply frequency selective surfaces in an antenna system to reduce mutual interference effects between two antenna elements. In more detail, the suggested antenna system comprises first and second antenna elements. The first antenna element is capable of transmitting in a first frequency range and the second antenna element is capable of transmitting in a second, non-overlapping frequency range.

In order to reduce interference effects, the antenna system additionally includes a frequency selective surface which is conductive to radio frequency energy in the first frequency range and reflective to radio frequency energy in the second frequency range. The frequency selective surface preferably has repetitive metallization pattern structures that display quasi band-pass or quasi band-reject filter characteristics to radio frequency signals impinging upon the frequency selective surface.

U.S. Pat. No. 6,917,340 B2 also relates to an antenna system comprising two antenna elements. In order to reduce the electromagnetic coupling and, hence, interference effects, one of the two antenna elements is subdivided into segments which have an electrical length corresponding to three/eight of the wavelength of the other antenna element. The segments of the one antenna element are electrically interconnected via electric reactance circuits which possess sufficiently high impedance in the frequency range of the other antenna element and sufficiently low impedance in the frequency range of the one antenna element.

Even though the above described approaches allow for a reduced inference in the radiation pattern of two antenna elements, the design of the antenna system comprising the two antenna elements becomes more complicated in view of the incorporation of additional components, namely the manufacturing and arrangement of the incorporation of electric reactance circuits. In particular, the design of the electric reactance circuits and their arrangement on the respective antenna element is complex and necessitates additional development steps. In addition, the components of the electric reactance circuit, as well as the soldered, electrical connection to the antenna elements introduce unacceptable variances to the frequency characteristic.

### SUMMARY

An antenna system, constructed in accordance with the present invention, includes a first planar antenna element arranged along an axis, at least one second antenna element arranged along the axis, and a planar parasitic element. The planar parasitic element is within the near-field of the first planar antenna element substantially in parallel to the first planar antenna element at a predetermined distance therefrom and with the center of the planar parasitic element offset with respect to the center of the first planar antenna element in a direction away from the at least one second antenna element along the axis. This construction of the present invention reduces a deformation of the radiating pattern of the first planar antenna element due to an interference with the at least one second antenna element.

The accompanying drawings are incorporated into the specification and form a part of the specification to illustrate several embodiments of the present invention. These drawings, together with a description, serve to explain the principles of the invention. The drawings are for the purpose of illustrating the preferred and alternative examples of how the invention can be made and used and are not to be construed as limiting the invention to only the illustrated and described embodiments.

Furthermore, several aspects of the embodiments may form, individually or in different combinations, solutions according to the present invention. Further features and advantages will be become apparent from the following description of the various embodiments of the invention as illustrated in the accompanying drawings, in which like references refer to like elements.

### BRIEF DESCRIPTION OF THE DRAWINGS

FIG. 1A is a perspective view of a first antenna of an antenna system according to a first embodiment of the present invention;

FIG. 1B is a perspective view of a second antenna of an antenna system according to the first embodiment of the present invention;

FIG. 1C shows a simulated radiating pattern of an antenna system according to the first embodiment of the present invention;

FIG. 2A is a perspective view of the first antenna of the antenna system of the first embodiment of the present invention useful for understanding the first embodiment of the present invention;

FIG. 2B is a perspective view of a second antenna of the antenna system of the first embodiment of the present invention useful for understanding the first embodiment of the present invention;

FIG. 2C shows a simulated radiating pattern of an antenna system according to the first embodiment of the present invention;

FIG. 3A is a perspective view of an antenna system according to a second embodiment of the present invention;

FIG. 3B shows a simulated radiating pattern of an antenna system according to the second embodiment of the present invention;

FIG. 4A is a perspective view of an antenna system useful for understanding the second embodiment of the present invention;

FIG. 4B shows a simulated radiating pattern of an antenna system according to the second embodiment of the present invention;

FIG. 5A shows a first planar antenna element of the present invention with a patch electrode on a dielectric substrate;

FIG. 5B is a side view of a second antenna element of antenna system according to the present invention;

FIG. 6A is a perspective view of an antenna system according to a third embodiment of the present invention;

FIG. 6B shows a simulated radiating pattern of an antenna system according to the third embodiment of the present invention;

FIG. 7A is a perspective view of an antenna system according to the third embodiment of the present invention useful for understanding the third embodiment of the present invention;

FIG. 7B shows a simulated radiating pattern according to the third embodiment of the present invention.

### DETAILED DESCRIPTION OF THE EMBODIMENT(S)

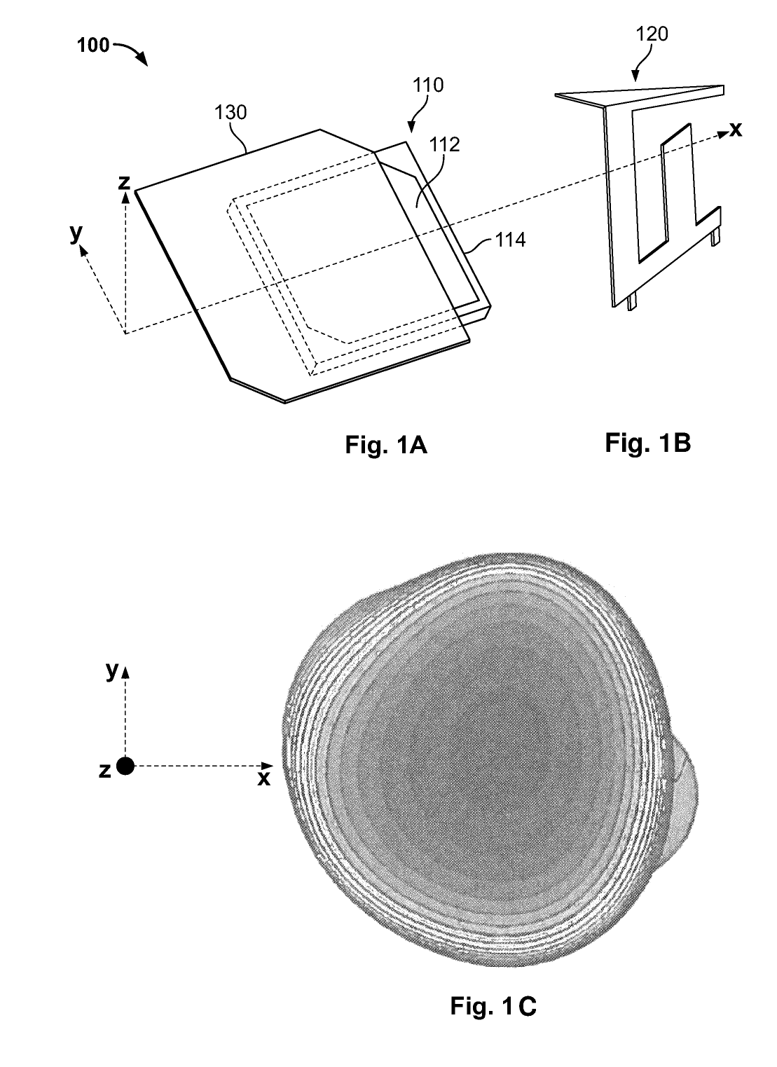

Referring to FIGS. 1A, 1B, and 1C, the antenna system 100 includes a first planar antenna element 110. In an exemplary configuration of the antenna system 100, the first planar antenna element 110 is a corner truncated rectangular patch antenna. The first planar antenna element 110 is capable of receiving/transmitting electromagnetic radio waves having a circular polarization. However, the first planar antenna element 110 is not restricted in this respect. The advantages of the antenna system 100 equally apply to configurations where the first planar antenna element 110 is capable of receiving/transmitting electromagnetic radio waves having a linear polarization.

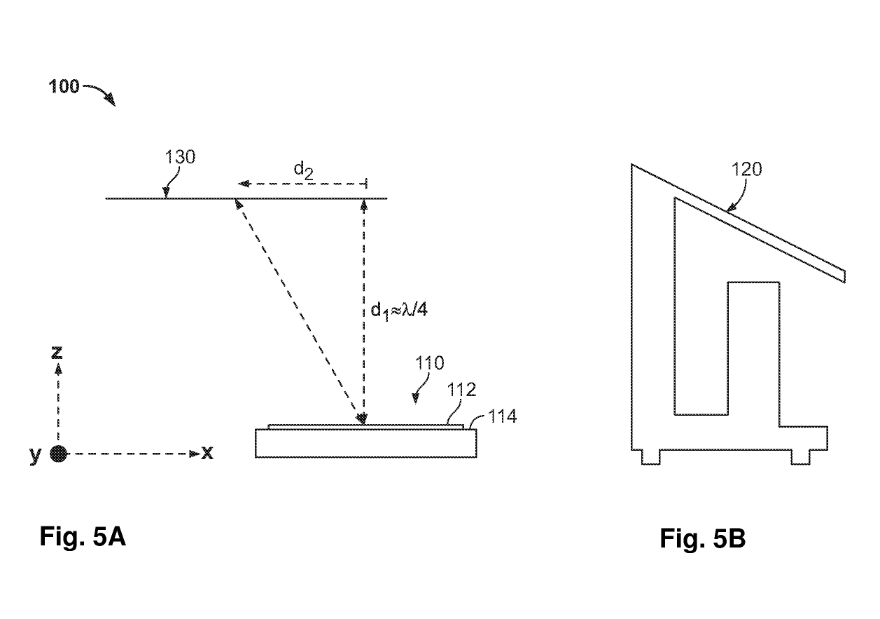

The first planar antenna element 110 includes a patch electrode 112 (or patch element), also shown in FIG. 5A, which is established, for example, by means of printing or etching on a dielectric substrate 114. In this respect, the dielectric substrate 114 provides structural support to the patch electrode 112 of the first planar antenna element 110. However, the first planar antenna element 110 is not restricted in this respect.

The advantages to the antenna system 100 equally apply to configurations where the first planar antenna element 110 includes a sheet electrode which is arranged at its predetermined position by, for example, a feed line which accordingly provides mechanical as well as electrical support to the sheet electrode of the first planar antenna element 110.

Further to the exemplary configuration of the antenna system 100, the dielectric substrate 114, on which the patch electrode 112 is provided to form the first planar antenna element 110, modifies the electrical size thereof. The dielectric substrate 114 has a relative permittivity ϵᵣ which affects the wavelength of the electromagnetic radio waves received/transmitted by the patch electrode 112 at some frequency. In particular, the higher the relative permittivity ϵᵣ of the dielectric substrate 114 of the first planar antenna element 110, the smaller the electrical size of the patch electrode 112 of the first planar antenna element 110. Accordingly, due to the position of the patch electrode 112 on the dielectric substrate 114, the patch electrode 112 of the first planar antenna element 110 has a reduced electrical size compared to its arrangement in air (i.e., without dielectric substrate).

Generally, the electrical size of the first planar antenna element 110 depends on the configuration thereof and may be different from the physical size of the structural elements of the first planar antenna element 110. Accordingly, further considerations with respect to an electromagnetic coupling of the first planar antenna element 110 and a planar parasitic element 130 mainly focus on the electrical size of both elements and not on their physical size.

In the context of the present invention, the term electrical size (or electrical length) shall be understood as referring to the length of an electrical conductor of an antenna in terms of the wavelength of the electromagnetic radio waves emitted by that conductor. In other words, the electrical size of the electrical conductor is determined by and may vary from the fixed physical size thereof.

Advantageously, an antenna gain is proportional to the electrical size of the antenna. At higher frequencies, more antenna gain can be obtained by increasing the electrical size of an antenna for a given physical antenna size. Accordingly, the first planar antenna element 110, including the patch electrode 112 on the dielectric substrate 114, advantageously results in an increase in antenna gain at high frequencies.

Still referring to FIGS. 1A, 1B, and 1C, antenna system 100 also includes at least one second antenna element 120. Even though the antenna system 100 is shown with only a single second antenna element 120, the present invention shall not be restricted in this respect. As will become apparent from, for instance, the third embodiment of the present invention, the principles of the antenna system 100 equally apply to antenna systems including a plurality of second antenna elements.

Due to the combination of the first planar antenna element 110 and the at least one second antenna element 120 within the antenna system 100, the first planar antenna element 110 and the at least one second antenna element 120 can interfere with each other, hence, resulting in adverse interference for the respective radiation patterns. Accordingly, in the absence of counter measures, the radiating patterns of the first planar antenna element 110 and the at least one second antenna element 120 would suffer from deformation due to the electromagnetic coupling between the antenna elements in the antenna system 100.

The at least one second antenna element 120 is a folded inverted-F antenna element. Accordingly, the at least one second antenna element 120 is particularly well suited for mobile communication, for instance, complying with long term evolution, LTE, specification for MIMO antennas as defined by 3GPP.

In a further exemplary configuration of the antenna system 100, the at least one second antenna element 120 is configured for lower frequencies than the first planar antenna element 110. Accordingly, the at least one second antenna element 120 has a large electrical size compared to the first planar antenna element 110. Due to this exemplary configuration, the first planar antenna element 110 particularly suffers from deformation due to the electromagnetic coupling therebetween.

Further to this exemplary configuration, the first planar antenna element 110 is adapted to a first frequency band. Therefore, it is capable of transmitting/receiving electromagnetic radio waves at frequencies within the first frequency band. The at least one second antenna element 120 is adapted to a second frequency band. Therefore, it is capable of transmitting/receiving electromagnetic radio waves at frequencies within the second frequency band. In particular, for this exemplary configuration, the first frequency band is higher or equal to the second frequency band.

In this exemplary configuration of the first planar antenna element 110 and the at least one second antenna element 120, the electrical size of the at least one second antenna element 120 is larger than or equal to a resulting electrical size of the first planar antenna element 110. Therefore, the electric shorter or equally sized first planar antenna element 110 is exposed to adverse interference by the at least one second antenna element 120, thereby resulting, in the absence of counter measures, in a deformed radiation pattern of the first planar antenna element 110.

Further to the antenna system 100, the first planar antenna element 110 and the at least one second antenna element 120 are arranged along a (i.e., single) axis (e.g., shown as x-axis in FIG. 1A). Accordingly, in the antenna system 100, the directivity of the radiating patterns of the first planar antenna element 110 and the at least one second antenna element 120, more particularly the azimuth angles ϑ and the elevation angles φ of the respective radiating patterns, have a predefined relationship to each other.

More particularly, the axis along which the first planar antenna element 110 and the at least one second antenna element 120 are arranged may correspond to a longitudinal (e.g., x-axis) or lateral axis (e.g., y-axis) of the antenna system 100. The arrangement of the first planar antenna element 110 and the at least one second antenna element 120 along an axis facilitates the antenna system 100 to be mounted on, for example, a vehicle rooftop in alignment with the longitudinal axis of the vehicle.

In a further exemplary configuration of the antenna system 100, the first planar antenna element 110 and the at least one second antenna element 120 are arranged within the near-field to each other. In particular, the at least one second antenna element 120 is arranged in the near-field of the first planar antenna element 110, (e.g., applying the definition of near-field for the first planar antenna element 110).

In the context of the present invention, the term near-field is understood as the region around each of the first planar antenna element 110 and the at least one second antenna element 120 where their radiating pattern is dominated by interference effects from the respective other of the first planar antenna element and the at least one second antenna element 120. For example, in case the first planar antenna element 110 and the at least one second antenna element 120 have electrical lengths shorter than one-half of the wavelength λ they are adapted to emit, the near-field is defined as the region with a radius r, where r<λ.

Further, the antenna system 100 additionally includes a planar parasitic element 130, also shown in FIG. 5A, which is within the near-field of the first planar antenna element 110, In particular, the first planar antenna element 110 and the planar parasitic element 130 are within the antenna system 100 such that the planar parasitic element 130 is electromagnetically coupled with the first planar antenna element 110. Moreover, the planar parasitic element 130 acts as a director to the first planar antenna element 110.

In the context of the present invention, the term parasitic element (or parasitic radiator) is construed as a conductive element without electrical connection to a RF power source. Accordingly, the parasitic element is solely “driven”, and hence radiates, due to electromagnetic coupling with another antenna element which itself is connected to a feeding line.

The planar parasitic element 130 is substantially in parallel to the first planar antenna element 110. As shown, for instance, in FIG. 5A, the first planar antenna element 110 and the planar parasitic element 130 both extend substantially in parallel in a plane defined by the x-y axis. As a result, a sufficiently strong electromagnetic coupling is realized between the first planar antenna element 110 and the planar parasitic element 130. In other words, a first plane defined by the extent of the first planar antenna element 110 and a second plane defined by the extent of the planar parasitic element 130 are substantially in parallel to each other. Tolerances to the parallel arrangement between the planar parasitic element 130 and the first planar antenna element 110 are in the region of 0° to 2° maximum angular deviation and may result from an inaccurate assembly of the two elements within the antenna system 100.

In yet another exemplary configuration of the antenna system 100, the planar parasitic element 130 is a sheet electrode which is held in place by a housing of the antenna system 100. In other words, a housing of the antenna system 100 provides mechanical support to the planar parasitic element 130 such that it is arranged within the near-field of the first planar antenna element 110.

The first planar antenna element 110 and the planar parasitic element 130 are arranged at a predetermined first distance d₁ from each other as shown in FIG. 5A. In other words, the planar parasitic element 130 is spaced at a predetermined first distance d₁ from the first planar antenna element 110, where the first distance allows for a sufficiently strong electromagnetic coupling between the planar parasitic element 130 and the first planar antenna element 110.

More specifically, the first distance d₁, between the first planar antenna element 110 and the planar parasitic element 130, results in a substantially perpendicular arrangement of the first planar antenna element 110 and the planar parasitic element 130. For example, the predetermined first distance d₁ between first planar antenna element 110 and the planar parasitic element 130 corresponds to separation along the vertical axis (e.g., z-axis in FIG. 5A) of the antenna system 100.

In a further exemplary configuration of the antenna system 100, the size and the shape of the planar parasitic element 130 and the first distance d₁ of the planar parasitic element from the first planar antenna element 110 are determined in accordance with the first planar antenna element 110. In particular, the first planar parasitic element 130 acts as director to the first planar antenna element 110 due to an accordingly determined physical size and shape and first distance d₁.

More particularly, for the planar parasitic element 130 to act as director to the first planar antenna element 110, planar parasitic element 130 has a reduced electrical size compared to that of the first planar antenna element 110. This reduced electrical size is advantageous to compensate for a phase shift of the transmitted electromagnetic radio wave due to the first distance d₁. Accordingly, the amount of reduction of the electrical size of the first planar antenna element 110 depends on the first distance d₁.

Specifically, it is emphasized in this respect that the electrical size of the various elements (i.e., the first planar antenna element 110 and the planar parasitic element 130) differs from their respective physical size due to, for instance, the different dielectric substrates arranged at close proximity thereto. For example, in this configuration of the antenna system 100, the planar parasitic element 130 has the same shape as the first planar antenna element 110, namely, the planar parasitic element 130 is a corner-truncated sheet electrode.

In an exemplary configuration of the antenna system 100, the first distance d₁ between the first planar antenna element 110 and the planar parasitic element 130 is between λ/10 and λ/4, where λ corresponds to a wavelength of the first planar antenna element, particularly to a wavelength of a frequency of the first frequency band to which the first planar antenna element 110 is adapted. In particular, a first distance d₁ that is λ/10 results in small phase shift of an induced current on the parasitic patch element 130 with respect to the first planar antenna element 110. In order to compensate for this small phase shift, the electrical size of the planar parasitic element 130 is only slightly reduced in comparison to that of the first planar antenna element 110. In other words, the electrical size of the parasitic patch element 130 is almost the same as the electrical size of the first planar antenna element 110.

Conversely, a first distance d₁ that is λ/4 causes a larger phase shift of an induced current on the parasitic patch element 130 with respect to the first planar antenna element 110. In order to compensate for this larger phase shift, the electrical size of the planar parasitic element 130 is substantially reduced in comparison to that of the first planar antenna element 110. In other words, the electrical size of the parasitic patch element 130 is decreased compared to that of the first planar antenna element 110 in order to compensate for this effect. The latter configuration may be advantageous for an antenna system with a limited amount of space.

In the antenna system 100, the center of the planar parasitic element 130 is offset with respect to the center of the first planar antenna element 110 in a second direction d₂ away from the at least one second antenna element 120, namely in a negative direction along the x-axis. In other words, the offset between the center of the planar parasitic element 130 and the center of first planar antenna element 110 is in a second direction d₂ that is opposite (i.e., in an opposite direction on the x-axis) with respect to the at least one second antenna element 120.

In more detail, in case the antenna system includes only a single second antenna element 120, as is the case in the present embodiment, the second direction is opposite with respect to that single second antenna element 120. In the case of a plurality of second antenna elements, the second direction is opposite to one of the plurality of second antenna elements with which the first planar antenna element predominantly interferes. This case is discussed in more detail in connection with the third embodiment of the present invention that is described below.

Advantageously, due to the offset of the center of the planar parasitic element 130 with respect to the center of the first planar antenna element 110 in a direction d₂ away from the at least one second antenna element 120, the same planar parasitic element 130 reduces a deformation of the radiating pattern of the first planar antenna element 110 in the antenna system 100. The deformation (e.g., deflection or displacement) of the radiating pattern of the first planar antenna element 110 is due to its interference with the at least one second antenna element 120.

In particular, the advantageous effect of reducing a deformation of the radiating pattern in the antenna system 100 is shown in FIG. 1C, where a simulated radiating pattern is that of the first planar antenna element 110. The simulated radiating pattern is shown in a top view with respect to the plane defined by the x and y axes of a coordinate system. The x, y, and z axes have a same orientation in all FIGS. 1C, 2C, and 3B. In this respect, it can be readily appreciated from FIG. 1C that the contour of the simulated radiating pattern of the first planar antenna element 110 is concentric with respect to the x-y plane and has only a minimum amount of deformation resulting from interference with the at least one second antenna element 120 in the antenna system 100.

In summary, the particular arrangement of the planar parasitic element 130 in the antenna system 100, in addition to the first planar antenna element 110 and the at least one second antenna element 120, allows for the beneficial effect that the interference between the individual antenna elements of the antenna system 100 is reduced, thereby improving the respective radiation patterns.

In addition, the antenna system 100 achieves this advantageous effect with the particular arrangement of the planar parasitic element 130 therein, namely without modifications to the first planar antenna element 110 or to the at least one second antenna element 120 and, hence, dispenses with the need for a more complicated design of the individual antenna elements.

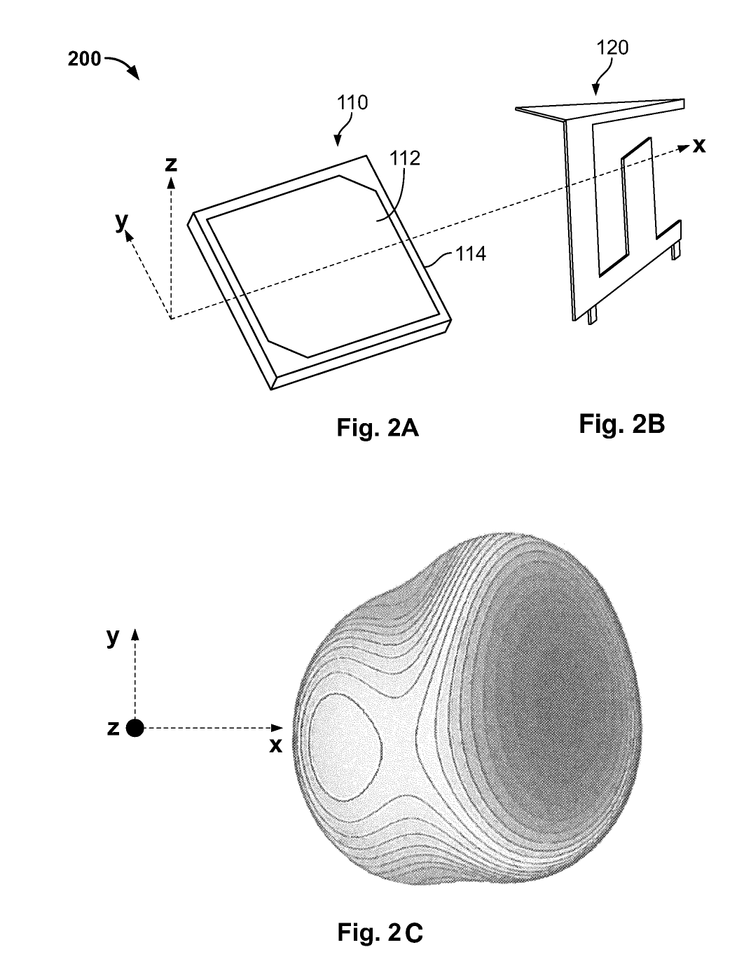

The advantageous design of the antenna system 100 becomes even more apparent when compared to a similar antenna system 200 shown in FIGS. 2A, 2B, and 2C which is similar to the antenna system 100, however, does not include the planar parasitic element 130 thereof. In particular, in FIGS. 2A, 2B, and 2C, a perspective view of an exemplary antenna system 200 useful for understanding the invention and a simulated radiating pattern thereof are shown. The antenna system 200 is based on the antenna system 100 of FIG. 1A where corresponding parts are given corresponding reference numerals and terms. The description of corresponding parts has been omitted for reasons of conciseness.

The shown antenna system 200 differs, however, from the antenna system 100 in that it does not include a parasitic element 130 and, hence, suffers from interference between the first planar antenna element 110 and the at least one second antenna element 120 both also included in the antenna system 200.

Due to the absence of the parasitic element in the antenna system 200, the simulated radiating pattern of the first planar antenna element 110 shown in FIG. 2C is deformed in a direction towards the at least one second antenna element 120. In other words, the contour of the simulated radiating pattern is not concentric with respect to the x-y plane. Instead the simulated radiating pattern of the first planar antenna element 110 is oriented in a positive direction along the x axis as result of the interference with the at least one second antenna element 120.

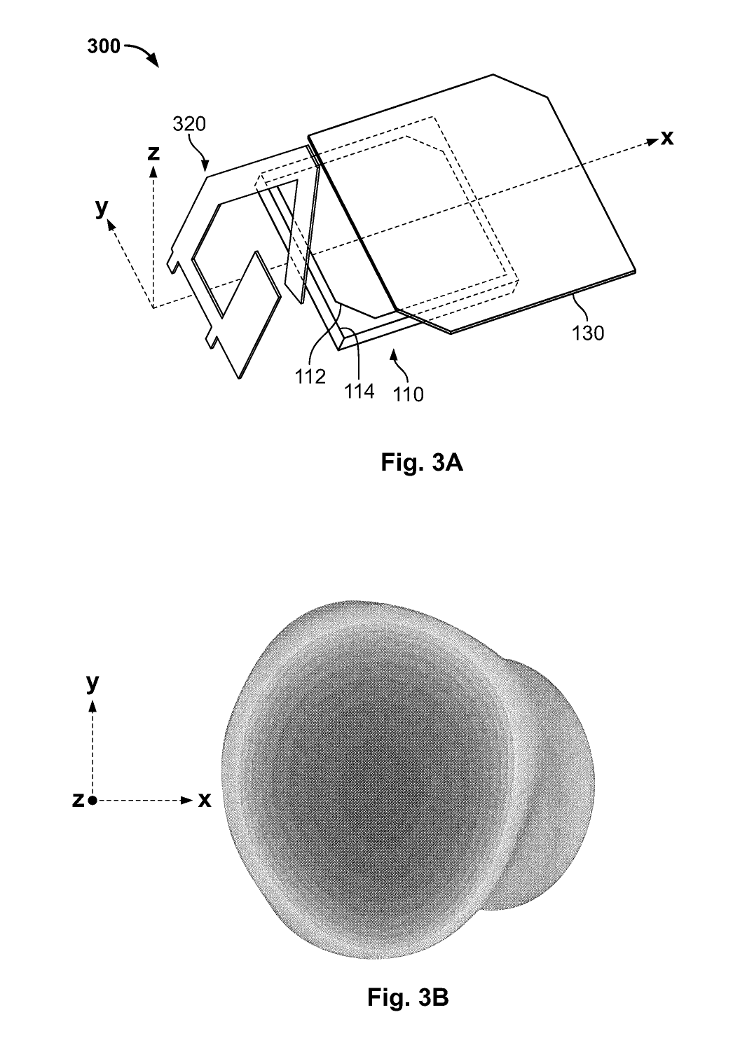

Referring now to FIGS. 3A and 3B, a perspective view of an exemplary antenna system 300 according to the second embodiment of the invention and a simulated radiating pattern thereof are shown. In particular, the simulated radiating pattern in FIG. 3B illustrates the advantageous effect resulting from the parasitic element included in the antenna system 300. The antenna system 300 is based on the antenna system 100 of FIG. 1A where corresponding parts are given corresponding reference numerals and terms. The description of corresponding parts has been omitted for reasons of conciseness.

The shown antenna system 300 differs, however, from the antenna system 100 in that it includes at least one different second antenna element 320 in addition to the first planar antenna element 110 and the planar parasitic element 130. The antenna system 300 comprises a first planar antenna element 110 and at least one second planar antenna element 320, wherein the first planar antenna element 110 and the at least one second planar antenna element 320 are arranged along an axis, namely the x axis. Further, the antenna system 300 comprises a planar parasitic element 130 arranged within the near-field of the first planar antenna element 110. The planar parasitic element 130 is arranged substantially in parallel to the first planar antenna element 110 and is arranged at a predetermined first distance d₁ therefrom.

Further, the center of the planar parasitic element 130 is offset with respect to the center of the first planar antenna element in a second direction d₂ away from the at least one second antenna element 320 along the axis, namely in a positive direction along the x axis. As a result, a deformation of the radiating pattern of the first planar antenna element 110, due to an interference with the at least one second antenna element 320, is reduced.

The same considerations for the arrangement of the planar parasitic element 130, discussed above with respect to the antenna system 100, also apply to the antenna system 200 thereby resulting in the same exemplary configurations thereto. The at least one different second antenna element 320 is a planar inverted-F antenna element. Accordingly, the at least one second antenna element 320 is particularly well suited for mobile communication, for instance, complying with long term evolution, LTE, specification for main antennas as defined by 3GPP.

In summary, the particular arrangement of the planar parasitic element 130 in the antenna system 300, in addition to the first planar antenna element and the at least one second antenna element 110 and 320, allows for the beneficial effect that the interference in between the individual antenna elements of the antenna system 300 is reduced, thereby improving the respective radiation patterns.

In addition, the antenna system 300 achieves this effect with the particular arrangement of the planar parasitic element 130 included, namely without modifications to the first planar antenna element or to the at least one second antenna element 110, 320 and, hence, dispenses with the need for a more complicated design of the individual antenna elements.

In particular, the advantageous effect of reducing a deformation of the radiating pattern in the antenna system 300 is shown in FIG. 3B, where a simulated radiating pattern is that of the first planar antenna element 110. The simulated radiating pattern is shown in a top view with respect to the plane defined by the x and y axes of a coordinate system. The x, y and z axes have a same orientation in both FIGS. 3A and 3B.

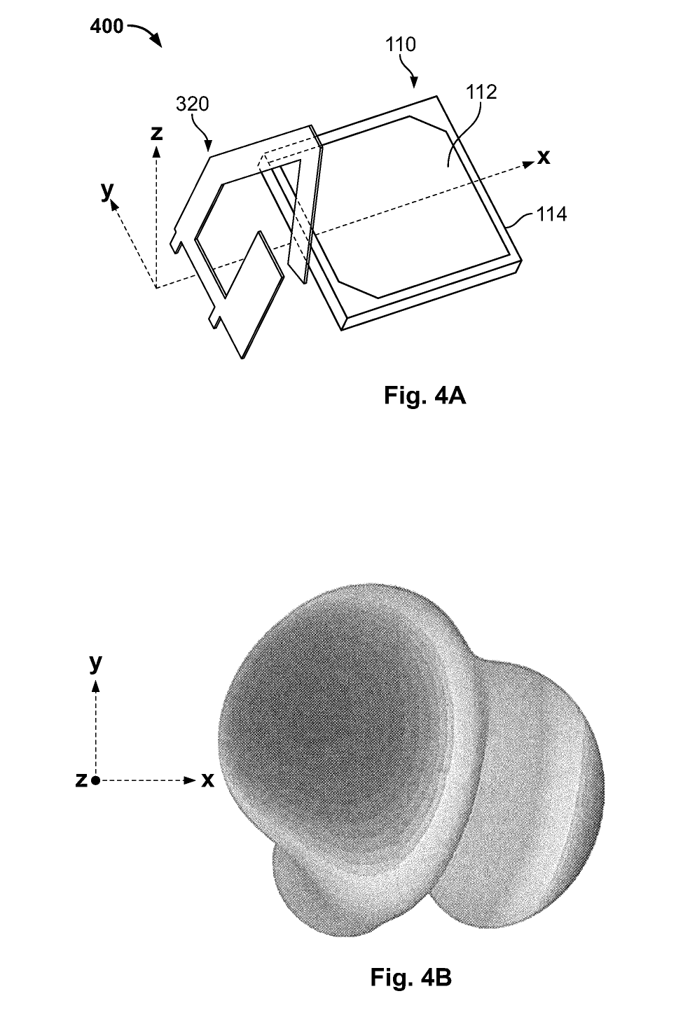

The advantageous effects of the antenna system 300 become even more apparent when compared to a similar antenna system 400, where FIGS. 4A and 4B show a perspective view of the exemplary antenna system 400 useful for understanding the invention and a simulated radiating pattern thereof. The antenna system 400 is based on the antenna system 300 of FIG. 3A where corresponding parts are given corresponding reference numerals and terms. The description of corresponding parts has been omitted for reasons of conciseness.

Due to the absence of the parasitic element in the antenna system 400, the simulated radiating pattern of the first planar antenna element 110 shown in FIG. 4B is deformed in a direction towards the at least one second antenna element 120, namely in a negative direction along the x axis. In other words, the contour of the simulated radiating pattern is not concentric with respect to the x-y plane.

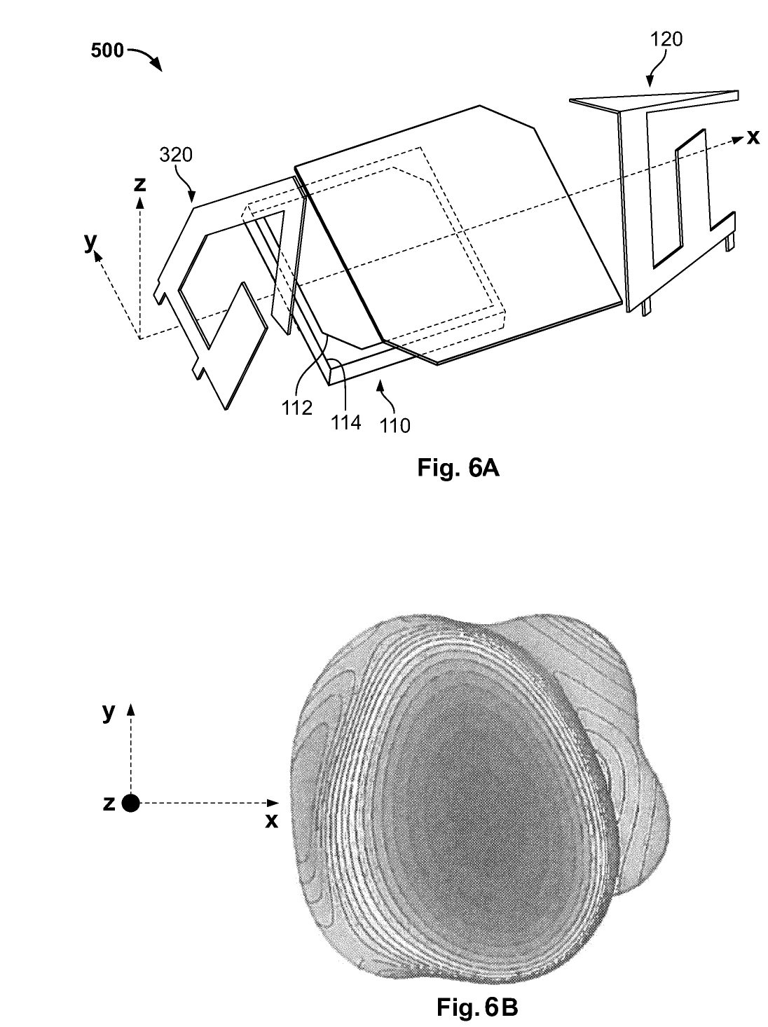

Referring now to FIGS. 6A and 6B, a perspective view of an exemplary antenna system 500 according to the third embodiment of the invention and a simulated radiating pattern thereof are shown. In particular, the simulated radiating pattern in FIG. 6B illustrates the advantageous effect resulting from the parasitic element included in the antenna system 500. The antenna system 500 is based on the antenna systems 100 and 300 of FIGS. 1A and 3A where corresponding parts are given corresponding reference numerals and terms. The description of corresponding parts has been omitted for reasons of conciseness.

The shown antenna system 500 differs, however, from the antenna system 100 and 300 in that it includes plural second antenna elements 120 and 320 in addition to the first planar antenna element 110 and the planar parasitic element 130. In more detail, the antenna system 500 comprises a first planar antenna element 110 and plural second planar antenna elements 120 and 320, wherein the first planar antenna element 110 and the plural second planar antenna elements 120 and 320 are arranged along an axis, namely the x axis in FIG. 6A, such that the first planar antenna element 110 is arranged in between two of the plurality of second antenna elements 120 and 320. Further, the antenna system 500 comprises a planar parasitic element 130 arranged within the near-field of the first planar antenna element 110. The planar parasitic element 130 is arranged substantially in parallel to the first planar antenna element 110 and is arranged at a predetermined first distance d₁ therefrom.

Further, the center of the planar parasitic element 130 is offset with respect to the center of the first planar antenna element 110 in a second direction d₂ away from a pre-dominantly interfering one of the plural second antenna elements 120 and 320 along the axis, namely in a positive direction along the x axis. As a result, a radiating pattern of the first planar antenna element 110, due to an interference with the at least one second antenna element 120, is reduced.

In the exemplary configuration of the antenna system 500, that one of the plural second antenna elements 120 and 320 interferes with the first planar antenna element 110 pre-dominantly which has a highest electromagnetic coupling to the first planar antenna element 110. Such a high electromagnetic coupling may result from, for instance, a similar size, shape or a smaller distance between the first planar antenna element 110 and the respective of the plural second antenna elements 120 and 320. In addition, by prescribing that the two second antenna elements 120 and 320, in between which the first planar antenna element 110 is arranged, have a different size, shape or are arranged at a different distance from the first planar antenna element 110 excludes the case that both of the second antenna elements 120 and 320 equally interfere with the first planar antenna element 110 such that there is no pre-dominant one. The same considerations for the arrangement of the planar parasitic element 130, discussed above with respect to the antenna system 100, also apply to the antenna system 500, thereby resulting in same exemplary configurations thereto.

In summary, the particular arrangement of the planar parasitic element 130 in the antenna system 500, in addition to the first planar antenna element 110 and the plural second antenna elements 120 and 320, allows for the beneficial effect that the interference in between the individual antenna elements of the antenna system 500 is reduced, thereby improving the respective radiation patterns.

In addition, the antenna system 500 achieves this effect with the particular arrangement of the planar parasitic element 130 included, namely without modifications to the first planar antenna element 110 or to the plural second antenna elements and 120 and 320 and, hence, dispenses with the need for a more complicated design of the individual antenna elements. In particular, the advantageous effect of reducing a deformation of the radiating pattern in the antenna system 500 is shown in FIG. 6B, where a simulated radiating pattern is that of the first planar antenna element 110. The simulated radiating pattern is shown in a top view with respect to the plane defined by the x and y axes of a coordinate system. The x, y and z axes have a same orientation in both FIGS. 6A and 6B.

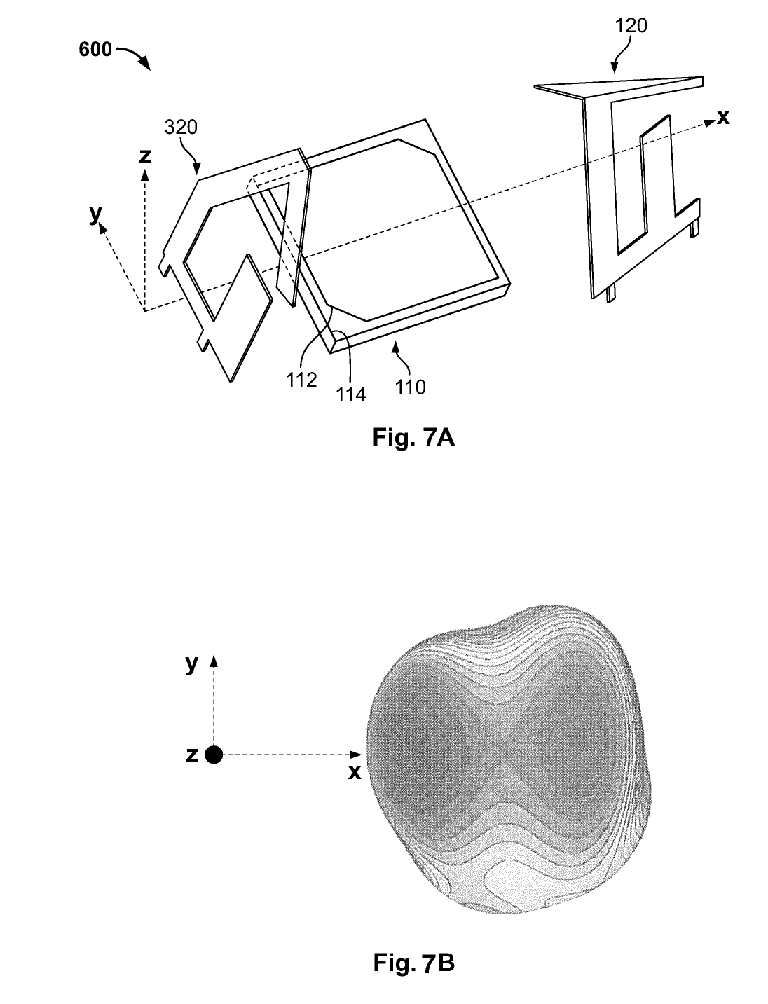

The advantageous effects of the antenna system 500 become even more apparent when compared to a similar antenna system 600, where FIGS. 7A and 7B show a perspective view of the exemplary antenna system 600 useful for understanding the present invention and a simulated radiating pattern thereof. The antenna system 600 is based on the antenna system 500 of FIG. 5A where corresponding parts are given corresponding reference numerals and terms. The description of corresponding parts has been omitted for reasons of conciseness.

Due to the absence of the parasitic element in the antenna system 600, the simulated radiating pattern of the first planar antenna element 110, shown in FIG. 7B, is deformed in a direction towards the at least one second antenna element 120, namely in a negative direction along the x axis. In other words, the contour of the simulated radiating pattern is not concentric with respect to the x-y plane.

Each of the above discussed antenna systems of the various embodiments can be included in an antenna module for use on a vehicle rooftop. For this purpose, the antenna module preferably comprises, in addition to the antenna system, a housing for protecting the antenna system from outside influences, a base for arranging the antenna system thereon, an antenna matching circuit, and an electrical connection for transmitting/receiving electrical signals from the outside to/from the first antenna element and the second antenna elements of the antenna system. Further, the vehicle rooftop provides for a ground plane to the first planar antenna element and the second antenna element of the antenna system.

What is claimed is:

1. An antenna system, comprising:
a first planar antenna element arranged along an axis;
at least one second antenna element arranged along the axis; and
a planar parasitic element:
(a) within the near-field of the first planar antenna element substantially in parallel to the first planar antenna element at a predetermined distance therefrom, and
(b) with the center of the planar parasitic element offset with respect to the center of the first planar antenna element in a direction away from the at least one second antenna element along the axis,
so as to reduce a deformation of the radiating pattern of the first planar antenna element due to an interference with the at least one second antenna element.

2. The antenna system according to claim 1, wherein each of the at least one second antenna element is within the near-field of the first planar antenna element.

3. The antenna system according to claim 2, wherein the first planar antenna element receives/transmits electromagnetic radio waves having a circular polarization.

4. The antenna system according to claim 3, wherein the first planar antenna element is a corner-truncated rectangular patch antenna element.

5. The antenna system according to claim 4, wherein the size and the shape of the planar parasitic element and the distance thereof from the first planar antenna element are determined in accordance with the first planar antenna element and/or the planar parasitic element having no electrical connection to an RF power source.

6. The antenna system according to claim 5, wherein the planar parasitic element has a reduced electrical size compared to that of the first planar antenna element which is determined in accordance with the distance thereof from the first planar antenna element.

7. The antenna system according to claims 6, wherein the planar parasitic element has the same shape as the first planar antenna element.

8. The antenna system according to claim 7, wherein the distance of the planar parasitic element from the first planar antenna element is between λ/10 and λ/4, where λ corresponds to a wavelength of the first planar antenna element.

9. The antenna system according to claims 8, wherein the first planar antenna element is adapted to a first frequency band, the at least one second antenna element is adapted to a second frequency band, and the first frequency band is higher or equal to the second frequency band.

10. The antenna system according to claim 9:
(a) further including a dielectric substrate,
(b) wherein first planar antenna element has a patch electrode, and
(c) wherein the patch electrode is on the dielectric substrate.

11. The antenna system according to claim 10, wherein the planar parasitic element is a sheet electrode which is held in place by a housing of the antenna system.

12. The antenna system according to claims 11, wherein the at least one second antenna element is one of an inverted-F antenna element and a folded inverted-F antenna element.

13. The antenna system according to claim 1, wherein:
(a) a plurality of second antenna elements are included in the antenna system, and
(b) the first planar antenna element is in between two of the plurality of second antenna elements, and
(c) the two second antenna elements, in between which the first planar antenna element is arranged, have different sizes and shapes compared to each other or are arranged at different distances from the first planar antenna element,
the center of the planar parasitic element is offset with respect to the center of the first planar element in a direction away from that one of the plurality of second planar antenna elements which predominantly interferes with the first planar antenna element.

14. The antenna system according to claim 1, wherein the center of first planar antenna element and bottom center of each of the at least one second antenna element are on the axis.

15. An antenna module for use on a vehicle rooftop, comprising an antenna system according to claim 1 with the axis of the antenna module aligned with the longitudinal axis of the vehicle and the vehicle rooftop provides for a ground plane to the first planar antenna element and the at least one second antenna element.
